(19) United States
(12) Patent Application Publication
(10) Pub. No.: US 2026/0125299 A1
(43) Pub. Date: May 7, 2026

(54) SEMICONDUCTOR MANUFACTURING WASTEWATER TREATMENT SYSTEM AND SEMICONDUCTOR MANUFACTURING WASTEWATER TREATMENT METHOD USING THE SAME

(71) Applicant: Samsung Electronics Co., Ltd., Suwon-si (KR)

(72) Inventors: Junyoung Oh, Suwon-si (KR); Changha Lee, Seoul (KR); Yunho Kim, Suwon-si (KR); Alim Jang, Seoul (KR); Minhyun Park, Seoul (KR); Younghun Kim, Suwon-si (KR); Jinhyeok Jang, Suwon-si (KR); Samjong Choi, Suwon-si (KR)

(73) Assignees: Samsung Electronics Co., Ltd., Suwon-si (KR); Seoul National University R&DB Foundation, Seoul (KR)

(21) Appl. No.: 19/375,422

(22) Filed: Oct. 31, 2025

(30) Foreign Application Priority Data
Nov. 7, 2024 (KR) 10-2024-0157163
Apr. 2, 2025 (KR) 10-2025-0043047

(51) Int. Cl. C02F 1/469; C02F 101/20; C02F 103/34

(52) U.S. Cl. CPC C02F 1/4695; C02F 2101/20; C02F 2103/346; C02F 2201/46

(57) ABSTRACT

A semiconductor manufacturing wastewater treatment system including a first tank configured to store semiconductor manufacturing wastewater containing a metal and silicate and an adsorption device configured to treat the semiconductor manufacturing wastewater supplied from the first tank, wherein the adsorption device includes a metal adsorption device configured to recover the metal from the semiconductor manufacturing wastewater supplied from the first tank and an impurity adsorption device configured to recover the silicate from the semiconductor manufacturing wastewater treated by the metal adsorption device.

### CROSS-REFERENCE TO RELATED APPLICATION

This application is based on and claims priority under 35 U.S. C. § 119 to Korean Patent Application Nos. 10-2024-0157163, filed on Nov. 7, 2024, and 10-2025-0043047, filed on Apr. 2, 2025, in the Korean Intellectual Property Office, the disclosures of which are incorporated by reference herein in their entireties.

### BACKGROUND

The inventive concept relates to a semiconductor manufacturing wastewater treatment system and a semiconductor manufacturing wastewater treatment method using the same.

To manufacture a semiconductor device, various semiconductor processes, such as a plating process, a planarization process, and a cleaning process, are performed. While performing the semiconductor processes, a large amount of semiconductor manufacturing wastewater is also generated. Semiconductor manufacturing wastewater includes various metals used in semiconductor device manufacturing. To prevent environmental contamination and reuse the metals, there is a demand for a technique capable of recovering metals in semiconductor manufacturing wastewater.

### SUMMARY

The inventive concept provides a semiconductor manufacturing wastewater treatment system capable of treating a large amount of semiconductor manufacturing wastewater and efficiently recovering metals from the semiconductor manufacturing wastewater, and a semiconductor manufacturing wastewater treatment method using the same.

According to an aspect of the inventive concept, there is provided a semiconductor manufacturing wastewater treatment system including a first tank configured to store semiconductor manufacturing wastewater containing a metal and silicate and an adsorption device configured to treat the semiconductor manufacturing wastewater supplied from the first tank, wherein the adsorption device includes a metal adsorption device configured to recover the metal from the semiconductor manufacturing wastewater supplied from the first tank and an impurity adsorption device configured to recover the silicate from the semiconductor manufacturing wastewater treated by the metal adsorption device.

According to another aspect of the inventive concept, there is provided a semiconductor manufacturing wastewater treatment system including a first tank configured to store semiconductor manufacturing wastewater containing a first metal, a second metal that is different from the first metal, and silicate, and an adsorption device configured to treat the semiconductor manufacturing wastewater supplied from the first tank, wherein the adsorption device includes a first metal adsorption device configured to recover the first metal from the semiconductor manufacturing wastewater supplied from the first tank, a second metal adsorption device configured to recover the second metal from the semiconductor manufacturing wastewater treated by the first metal adsorption device, and an impurity adsorption device configured to recover the silicate from the semiconductor manufacturing wastewater treated by the second metal adsorption device.

According to another aspect of the inventive concept, there is provided a semiconductor manufacturing wastewater treatment system including a first tank configured to store semiconductor manufacturing wastewater containing a metal and silicate, an adsorption device configured to treat the semiconductor manufacturing wastewater supplied from the first tank, a second tank configured to store process treatment water formed by treating the semiconductor manufacturing wastewater by the adsorption device, and a concentration meter configured to measure a metal concentration of the process treatment water, wherein the adsorption device includes a metal adsorption device =configured to recover the metal from the semiconductor manufacturing wastewater supplied from the first tank and including a membrane capacitive deionization (MCDI) device and an impurity adsorption device configured to recover the silicate from the semiconductor manufacturing wastewater treated by the metal adsorption device and including a hybrid capacitive deionization (HCDI) device.

According to another aspect of the inventive concept, there is provided a method of treating semiconductor manufacturing wastewater including supplying semiconductor manufacturing wastewater containing a metal and silicate from a first tank to a metal adsorption device and treating the semiconductor manufacturing wastewater in the metal adsorption device to remove the metal from the semiconductor manufacturing wastewater and recover the metal; supplying the semiconductor manufacturing wastewater treated by the metal adsorption device to an impurity adsorption device and removing the silicate from the semiconductor manufacturing wastewater to form process treatment water; supplying the process treatment water to a second tank; and measuring concentration of the metal in the process treatment water in the second tank.

### BRIEF DESCRIPTION OF THE DRAWINGS

Embodiments of the inventive concept will be more clearly understood from the following detailed description taken in conjunction with the accompanying drawings in which:

FIG. 1 is a block diagram schematically illustrating a semiconductor manufacturing wastewater treatment system according to embodiments;

FIG. 2A is a cross-sectional view schematically illustrating a metal adsorption device included in a semiconductor manufacturing wastewater treatment system according to embodiments;

FIG. 2B is a cross-sectional view schematically illustrating an impurity adsorption device included in a semiconductor manufacturing wastewater treatment system according to embodiments;

FIG. 3 is a block diagram schematically illustrating a semiconductor manufacturing wastewater treatment system according to embodiments;

FIG. 4 is a flowchart illustrating a semiconductor manufacturing wastewater treatment method according to embodiments;

FIG. 5 is a flowchart illustrating a semiconductor manufacturing wastewater treatment method according to embodiments;

FIG. 6 is a flowchart illustrating a semiconductor manufacturing wastewater treatment method according to embodiments;

FIG. 7A is a graph illustrating a temporal change in the concentration of a metal included in semiconductor manufacturing wastewater treated by a semiconductor manufacturing wastewater treatment method according to embodiments;

FIG. 7B illustrates a temporal change in the color of semiconductor manufacturing wastewater treated by a semiconductor manufacturing wastewater treatment method according to embodiments;

FIG. 7C is a graph illustrating a temporal change in the concentration of each of a metal and silicate included in semiconductor manufacturing wastewater treated by a semiconductor manufacturing wastewater treatment method according to embodiments;

FIG. 8A is a graph illustrating a temporal change in the concentration of each of metals and silicate included in semiconductor manufacturing wastewater treated by a semiconductor manufacturing wastewater treatment method according to embodiments; and

FIG. 8B is a graph illustrating a temporal change in the pH of semiconductor manufacturing wastewater treated by a semiconductor manufacturing wastewater treatment method according to embodiments.

### DETAILED DESCRIPTION OF THE EMBODIMENTS

Embodiments are described herein in detail with reference to the accompanying drawings. Like reference numerals in the drawings denote like elements, and thus their repetitive description will be omitted.

Items described in the singular herein may be provided in plural, as can be seen, for example, in the drawings. Thus, the description of a single item that is provided in plural should be understood to be applicable to the remaining plurality of items unless context indicates otherwise.

Spatially relative terms, such as ““above,” “below” and the like, may be used herein for ease of description to describe positional relationships, such as illustrated in the figures, for example. It will be understood that the spatially relative terms encompass different orientations of the device in addition to the orientation depicted in the figures.

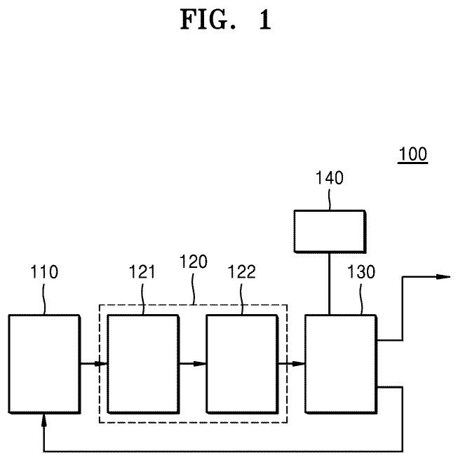

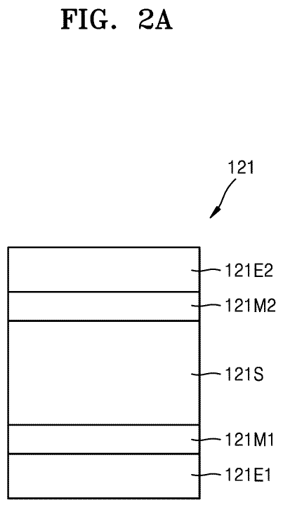

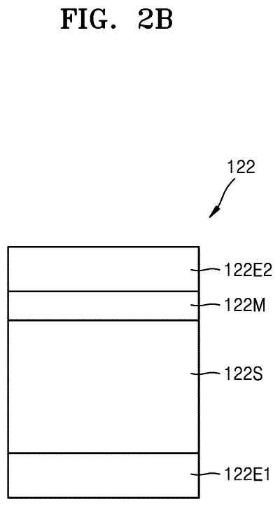

FIG. 1 is a block diagram schematically illustrating a semiconductor manufacturing wastewater treatment system 100 according to embodiments. FIG. 2A is a cross-sectional view schematically illustrating a metal adsorption device 121 included in the semiconductor manufacturing wastewater treatment system 100 according to embodiments. FIG. 2B is a cross-sectional view schematically illustrating an impurity adsorption device 122 included in the semiconductor manufacturing wastewater treatment system 100 according to embodiments.

Referring to FIGS. 1, 2A, and 2B, the semiconductor manufacturing wastewater treatment system 100 may include a first tank 110, an adsorption device 120, and a second tank 130. The first tank 110 may temporarily store semiconductor manufacturing wastewater generated by a semiconductor process after performing the semiconductor process. The semiconductor process may include, for example, a plating process, a chemical mechanical polishing (CMP) process, and the like but is not limited thereto. The semiconductor manufacturing wastewater generated by the semiconductor process may include a metal and silicate. For example, when the semiconductor process is a plating process, the semiconductor manufacturing wastewater may include a metal, such as copper (Cu), tin (Sn), silver (Ag), nickel (Ni), tungsten (W), ruthenium (Ru), cobalt (Co), gold (Au), or tantalum (Ta), or combinations thereof, and when the semiconductor process is a Cu CMP process, for example, the semiconductor manufacturing wastewater may include Cu, silicon (Si), and the like, or combinations thereof. In example embodiments, Si included in the semiconductor manufacturing wastewater may be in a form of silicate.

While the semiconductor manufacturing wastewater is stored in the first tank 110, the pH of the semiconductor manufacturing wastewater may be adjusted. By adjusting the pH of the semiconductor manufacturing wastewater, the metal included in the semiconductor manufacturing wastewater may be efficiently recovered in a process of treating the semiconductor manufacturing wastewater by using the adsorption device 120.

The adsorption device 120 may adsorb and recover the metal and silicate included in the semiconductor manufacturing wastewater from the semiconductor manufacturing wastewater by treating the semiconductor manufacturing wastewater supplied from the first tank 110. It should be understood that when referencing adsorbing and recovering the metal and silicate herein, it is possible that not all of the metal and silicate are adsorbed, but at least some portion of the metal and silicate may be adsorbed. Similarly, when referring to removing of the metal or silicate from the semiconductor manufacturing wastewater, the removing may be all or a part of the metal or silicate from the semiconductor manufacturing wastewater. The adsorption device 120 may include the metal adsorption device 121 and the impurity adsorption device 122.

The metal adsorption device 121 may be for example, a membrane capacitive deionization (MCDI) adsorption device. The metal adsorption device 121 may include a spacer 121S, a first electrode 121E1 and a second electrode 121E2 disposed on the upper surface of (above) the spacer and disposed on the lower surface of (below) the spacer 121S, respectively, and facing each other with the spacer 121S therebetween, a first ion exchange membrane 121M1 provided between the first electrode 121E1 and the spacer 121S, and a second ion exchange membrane 121M2 provided between the second electrode 121E2 and the spacer 121S.

The spacer 121S may be disposed between the first electrode 121E1 and the second electrode 121E2 to prevent a direct short circuit between the first electrode 121E1 and the second electrode 121E2 and configured such that the semiconductor manufacturing wastewater supplied to the metal adsorption device 121 flows between the first electrode 121E1 and the second electrode 121E2. For example, the spacer 121S may include a polymer having a porous structure or ceramic. The polymer having a porous structure may include or be, for example, polyethylene, polypropylene, or nylon.

The first electrode 121E1 and the second electrode 121E2 may be configured to adsorb and desorb the metal included in the semiconductor manufacturing wastewater supplied to the metal adsorption device 121. For example, when a voltage is applied to the first electrode 121E1 and the second electrode 121E2, metal cations included in the semiconductor manufacturing wastewater may be adsorbed to any one of the first electrode 121E1 and the second electrode 121E2, and anions may be adsorbed to the other of the first electrode 121E1 and the second electrode 121E2. In addition, when no voltage or an opposite voltage is applied to the first electrode 121E1 and the second electrode 121E2, the metal cations adsorbed to any one of the first electrode 121E1 and the second electrode 121E2 may be desorbed, and the anions adsorbed to the other of the first electrode 121E1 and the second electrode 121E2 may be desorbed. Herein, the opposite voltage may indicate a voltage having the same absolute value as and the opposite sign to that of the voltage applied to the first electrode 121E1 and the second electrode 121E2. The desorbed metal cations and anions may be recovered from the metal adsorption device 121 by a separate solution. The separate solution may be, for example, ultra-pure water.

In example embodiments, the first electrode 121E1 may be a negative electrode, and the second electrode 121E2 may be a positive electrode. In this example, when the voltage is applied to the first electrode 121E1 and the second electrode 121E2, the metal cations included in the semiconductor manufacturing wastewater may be adsorbed to the first electrode 121E1, and the anions included in the semiconductor manufacturing wastewater may be adsorbed to the second electrode 121E2. However, the technical idea of the inventive concept is not limited thereto, and the first electrode 121E1 may be a positive electrode, and the second electrode 121E2 may be a negative electrode. In this example, when the voltage is applied to the first electrode 121E1 and the second electrode 121E2, the anions included in the semiconductor manufacturing wastewater may be adsorbed to the first electrode 121E1, and the metal cations included in the semiconductor manufacturing wastewater may be adsorbed to the second electrode 121E2.

The voltage applied to the first electrode 121E1 and the second electrode 121E2 may be, for example, about −18 V to about 18 V or −17 V to 17 V or −19 V to 19 V. The voltage applied to the first electrode 121E1 and the second electrode 121E2 may be adjusted according to the type of metal cations included in the semiconductor manufacturing wastewater supplied to the metal adsorption device 121.

In embodiments, each of the first electrode 121E1 and the second electrode 121E2 may include or be porous carbon.

The first ion exchange membrane 121M1 may be provided between the first electrode 121E1 and the spacer 121S, and the second ion exchange membrane 121M2 may be provided between the second electrode 121E2 and the spacer 121S. The first ion exchange membrane 121M1 and the second ion exchange membrane 121M2 may be configured to improve the adsorption efficiency of the metal cations and the anions, respectively, in a metal cation and anion adsorption process using the metal adsorption device 121.

In embodiments, when the first electrode 121E1 is a positive electrode and the second electrode 121E2 is a negative electrode, the first ion exchange membrane 121M1 may be an anion exchange membrane, and the second ion exchange membrane 121M2 may be a cation exchange membrane. In example embodiments, the first ion exchange membrane 121M1 may include or be, for example, a quaternary ammonium-based polymer, and the second ion exchange membrane 121M2 may include or be, for example, a sulfonated polymer.

In embodiments, when the first electrode 121E1 is a negative electrode and the second electrode 121E2 is a positive electrode, the first ion exchange membrane 121M1 may be a cation exchange membrane, and the second ion exchange membrane 121M2 may be an anion exchange membrane. In example embodiments, the first ion exchange membrane 121M1 may include or be, for example, a sulfonated polymer, and the second ion exchange membrane 121M2 may include or be, for example, a quaternary ammonium-based polymer.

The impurity adsorption device 122 may be a hybrid capacitive deionization (HCDI) adsorption device. The impurity adsorption device 122 may be connected in series to the metal adsorption device 121. The impurity adsorption device 122 may include a spacer 122S, a first electrode 122E1 and a second electrode 122E2 disposed on the upper surface of (above) and disposed on the lower surface of (below) the spacer 122S, respectively, and facing each other with the spacer 122S therebetween, and an ion exchange membrane 122M provided between the second electrode 122E2 and the spacer 122S.

The spacer 122S may be disposed between the first electrode 122E1 and the second electrode 122E2 to prevent a direct short circuit between the first electrode 122E1 and the second electrode 122E2 and configured such that the semiconductor manufacturing wastewater supplied to the impurity adsorption device 122 flows between the first electrode 122E1 and the second electrode 122E2. For example, the spacer 122S may include a polymer having a porous structure or ceramic. The polymer having a porous structure may include or be, for example, polyethylene, polypropylene, or nylon.

The first electrode 122E1 and the second electrode 122E2 may be configured to adsorb and desorb the silicate included in the semiconductor manufacturing wastewater supplied to the impurity adsorption device 122. In embodiments, the first electrode 122E1 may be a negative electrode, and the second electrode 122E2 may be a positive electrode. For example, when a voltage is applied to the first electrode 122E1 and the second electrode 122E2, the silicate included in the semiconductor manufacturing wastewater may be adsorbed to the second electrode 122E2 that is a positive electrode, and water may be reduced at the first electrode 122E1 that is a negative electrode. As water is reduced at the first electrode 122E1, the pH of the semiconductor manufacturing wastewater supplied to the impurity adsorption device 122 in a silicate adsorption process may increase. As the pH of the semiconductor manufacturing wastewater increases, the silicate included in the semiconductor manufacturing wastewater may be dissociated better, and thus, the silicate may be further efficiently adsorbed without a separate pH adjustment process.

In addition, when no voltage or an opposite voltage is applied to the first electrode 122E1 and the second electrode 122E2, the silicate adsorbed to the second electrode 122E2 that is a positive electrode may be desorbed. Herein, the opposite voltage may indicate a voltage having the same absolute value as and an opposite sign to that of the voltage applied to the first electrode 122E1 and the second electrode 122E2.

The voltage applied to the first electrode 122E1 and the second electrode 122E2 may be, for example, about −18 V to about 18 V, or −17 V to 17 V, or −19 V to 19 V.

In embodiments, the first electrode 122E1 may include or be graphite, and the second electrode 122E2 may include or be porous carbon.

The ion exchange membrane 122M may be provided between the second electrode 122E2 and the spacer 122S. The ion exchange membrane 122M may be configured to improve silicate adsorption efficiency in a silicate adsorption process using the impurity adsorption device 122. In embodiments, the ion exchange membrane 122M may be an anion exchange membrane. The ion exchange membrane 122M may include or be, for example, a quaternary ammonium-based polymer.

The semiconductor manufacturing wastewater from which the metal cations and the silicate have been recovered and removed by the adsorption device 120 may flow toward the second tank 130, and the second tank 130 may temporarily store the semiconductor manufacturing wastewater.

The semiconductor manufacturing wastewater treatment system 100 may further include a concentration meter 140. The concentration meter 140 may be, for example, an ultraviolet visible (UV-Vis) spectroscopy device. The concentration meter 140 may measure the concentration of the metal included in the semiconductor manufacturing wastewater while the semiconductor manufacturing wastewater treated by the adsorption device 120 is temporarily stored in the second tank 130. When the measured concentration of the metal is a preset value or less, the semiconductor manufacturing wastewater stored in the second tank 130 may be discharged from the second tank 130. Otherwise, when the measured concentration of the metal is greater than the preset value, the semiconductor manufacturing wastewater may be resupplied from the second tank 130 to the first tank 110, and the semiconductor manufacturing wastewater resupplied to the first tank 110 may be retreated by the adsorption device 120.

The semiconductor manufacturing wastewater treatment system 100 according to embodiments may include the adsorption device 120 including the metal adsorption device 121 and the impurity adsorption device 122. Because a metal is recovered from semiconductor manufacturing wastewater by capacitive deionization (CDI), a large amount of semiconductor manufacturing wastewater may be treated, and the metal included in the semiconductor manufacturing wastewater may be recovered in an eco-friendly manner. In addition, when a voltage is applied to the impurity adsorption device 122, water may be reduced such that the pH of semiconductor manufacturing wastewater supplied to the impurity adsorption device 122 increases, and accordingly, silicate included in the semiconductor manufacturing wastewater may be dissociated better than in other methods, thereby improving the recovery efficiency of the silicate without a separate treatment.

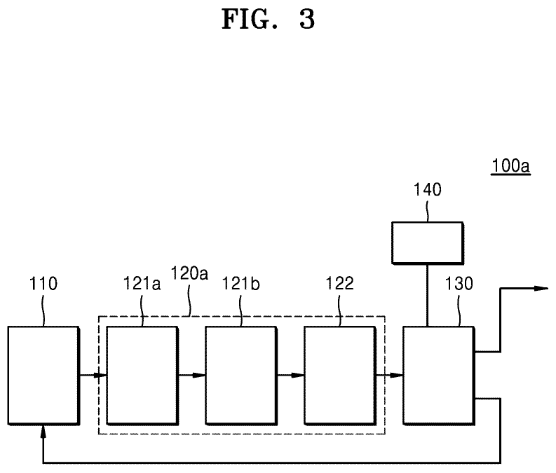

FIG. 3 is a block diagram schematically illustrating a semiconductor manufacturing wastewater treatment system 100a according to embodiments. The components in the semiconductor manufacturing wastewater treatment system 100a shown in FIG. 3 may be the same as the components in the semiconductor manufacturing wastewater treatment system 100 shown in FIGS. 1, 2A, and 2B, and thus, the differences therebetween are mainly described below. As indicated above, like reference numerals throughout the application may have the same descriptions.

Referring to FIG. 3, the semiconductor manufacturing wastewater treatment system 100a may have a similar configuration to that of the semiconductor manufacturing wastewater treatment system 100 shown in FIGS. 1, 2A, and 2B except that the semiconductor manufacturing wastewater treatment system 100a includes a plurality of metal adsorption devices 121a and 122b. The semiconductor manufacturing wastewater treatment system 100a may include the first tank 110, an adsorption device 120a, and the second tank 130.

The first tank 110 may temporarily store semiconductor manufacturing wastewater generated by a semiconductor process after performing the semiconductor process. The semiconductor manufacturing wastewater may include, for example, at least two types of metals and silicate. For example, the semiconductor manufacturing wastewater may include Cu, Ru, and silicate.

The adsorption device 120a may adsorb and recover the metals and the silicate included in the semiconductor manufacturing wastewater from the semiconductor manufacturing wastewater by treating the semiconductor manufacturing wastewater supplied from the first tank 110. The adsorption device 120a may include the plurality of metal adsorption devices 121a and 122b and the impurity adsorption device 122. Each metal adsorption device of the plurality of metal adsorption devices 121a and 121b may be an MCDI adsorption device, and the impurity adsorption device 122 may be an HCDI adsorption device. The configuration of each metal adsorption device of the plurality of metal adsorption devices 121a and 121b may be the same or substantially the same as the configuration of the metal adsorption device 121 of the semiconductor manufacturing wastewater treatment system 100 described with reference to FIG. 2A, and the configuration of the impurity adsorption device 122 of the semiconductor manufacturing wastewater treatment system 100a may be the same or substantially the same as the configuration of the impurity adsorption device 122 of the semiconductor manufacturing wastewater treatment system 100 described with reference to FIG. 2B.

The plurality of metal adsorption devices 121a and 121b may include a first metal adsorption device 121a and a second metal adsorption device 121b. The first metal adsorption device 121a may be connected in series to the second metal adsorption device 121b. The first metal adsorption device 121a and the second metal adsorption device 121b may be configured to adsorb and desorb metals included in semiconductor manufacturing wastewater. In example embodiments, two types of metals included in the semiconductor manufacturing wastewater may be recovered from the semiconductor manufacturing wastewater by the plurality of metal adsorption devices 121a and 121b by using the difference between the standard reduction potentials of the two types of metals. For example, when the semiconductor manufacturing wastewater includes Cu and Ru, a voltage may be applied to the first metal adsorption device 121a to adsorb Cu and Ru, then Cu having a relatively higher standard reduction potential may be recovered by the first metal adsorption device 121a, the semiconductor manufacturing wastewater from which Cu has been recovered may be supplied to the second metal adsorption device 121b, a voltage may be applied to the second metal adsorption device 121b to adsorb Ru, and then the adsorbed Ru may be recovered. Although FIG. 3 shows that the adsorption device 120a includes two adsorption devices 121a and 121b, the technical idea of the inventive concept is not limited thereto. For example, unlike shown in FIG. 3, the adsorption device 120a may include three or more metal adsorption devices. In this example, when semiconductor manufacturing wastewater includes three or more types of metals, the three or more types of metals may be sequentially recovered by the three or more metal adsorption devices by using the differences among the standard reduction potentials of the three or more types of metals, respectively.

The impurity adsorption device 122 may be connected in series to the plurality of metal adsorption devices 121a and 121b. The impurity adsorption device 122 may be configured to recover silicate from the semiconductor manufacturing wastewater treated by the plurality of metal adsorption devices 121a and 121b.

The semiconductor manufacturing wastewater from which metal cations and the silicate have been recovered and removed by the adsorption device 120a may flow toward the second tank 130, and the second tank 130 may temporarily store the semiconductor manufacturing wastewater.

The semiconductor manufacturing wastewater treatment system 100a may further include a concentration meter 140. The concentration meter 140 may be, for example, a UV-Vis spectroscopy device. The concentration meter 140 may measure the concentration of the metals included in the semiconductor manufacturing wastewater (also referred to herein as “process treatment water” at this stage in the process) while the semiconductor manufacturing wastewater that has been treated by the adsorption device 120a is temporarily stored in the second tank 130. When the measured concentration of the metals is a preset value or less, the semiconductor manufacturing wastewater stored in the second tank 130 may be discharged from the second tank 130. Otherwise, when the measured concentration of the metals is greater than the preset value, the semiconductor manufacturing wastewater may be resupplied from the second tank 130 to the first tank 110, and the semiconductor manufacturing wastewater resupplied to the first tank 110 may be retreated by the adsorption device 120a a second or more time.

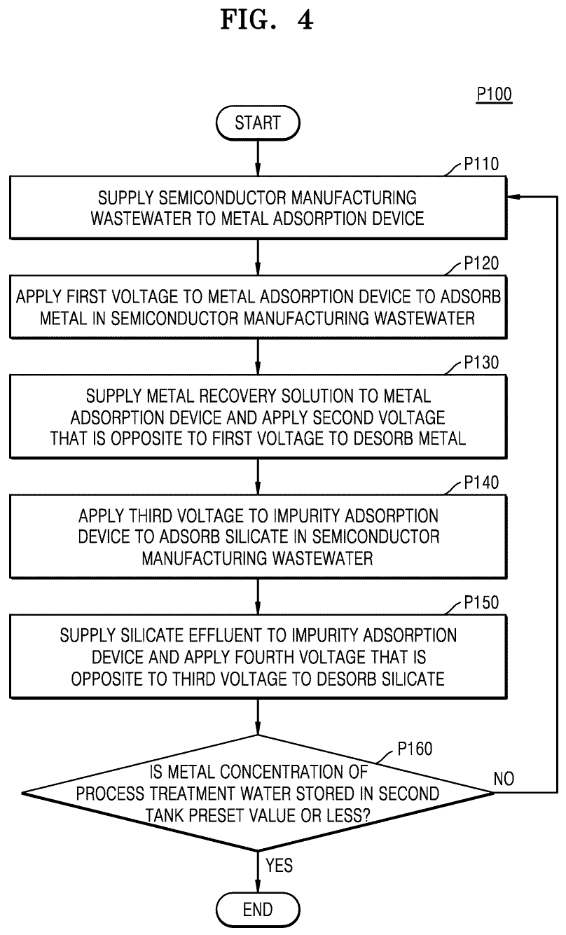

FIG. 4 is a flowchart illustrating an example semiconductor manufacturing wastewater treatment method P100 according to example embodiments.

Referring to FIGS. 1, 2A, 2B, and 4, semiconductor manufacturing wastewater may be supplied from the first tank 110 to the metal adsorption device 121 in operation P110. The semiconductor manufacturing wastewater may be generated by performing a semiconductor process, such as a plating process or a CMP process. The semiconductor manufacturing wastewater may include a metal and silicate. The metal may include or be, for example, at least one of Cu, Sn, Ag, Ni, W, Ru, Co, Au, or Ta. In embodiments, prior to operation P110, the pH of the semiconductor manufacturing wastewater may be adjusted until the semiconductor manufacturing wastewater stored in the first tank 110 is under an acidic condition. When the semiconductor manufacturing wastewater is under the acidic condition, the metal may exist in the form of cations, and the silicate may exist in the form of salt.

Next, a first voltage may be applied to the first electrode 121E1 and the second electrode 121E2 of the metal adsorption device 121 in operation P120. For convenience of description, the semiconductor manufacturing wastewater treatment method P100 is described herein assuming that the first electrode 121E1 is a negative electrode and the second electrode 121E2 is a positive electrode, but the technical idea of the inventive concept is not limited thereto. In response to applying the first voltage, metal cations in the semiconductor manufacturing wastewater may be adsorbed to the first electrode 121E1 that is a negative electrode. Because the first electrode 121E1 may include or be porous carbon, the metal cations may be physically adsorbed to a porous structure of the first electrode 121E1. The first voltage may be, for example, about −18 V to about 18 V. The first voltage may vary according to the type of metal included in the semiconductor manufacturing wastewater.

The semiconductor manufacturing wastewater on which operation P120 has been performed may be supplied to the impurity adsorption device 122.

Next, in operation P130, a metal recovery solution may be supplied to the metal adsorption device 121, and a second voltage may be applied to the first electrode 121E1 and the second electrode 121E2 of the metal adsorption device 121. The metal recovery solution may be, for example, ultra-pure water. The second voltage may be opposite to the first voltage. For example, when the first voltage is 1.2 V, the second voltage may be −1.2 V. When the second voltage is applied to the first electrode 121E1 and the second electrode 121E2 of the metal adsorption device 121, the metal cations adsorbed to the first electrode 121E1 may be desorbed and dissolved in the metal recovery solution. Thereafter, the metal recovery solution may be collected by the metal adsorption device 121 and subsequently treated to recover the metal from the metal cations included in the metal recovery solution. Although it is illustrated in FIG. 4 that the second voltage is opposite to the first voltage, the technical idea of the inventive concept is not limited thereto. For example, operation P130 may be performed by supplying the metal recovery solution to the metal adsorption device 121 and applying no voltage to the first electrode 121E1 and the second electrode 121E2 of the metal adsorption device 121. When no voltage is applied to the first electrode 121E1 and the second electrode 121E2 of the metal adsorption device 121, the metal cations adsorbed to the first electrode 121E1 of the metal adsorption device 121 by the first voltage may be desorbed from the first electrode 121E1.

Next, a third voltage may be applied to the first electrode 122E1 and the second electrode 122E2 of the impurity adsorption device 122 in operation P140. In response to applying the third voltage, water included in the semiconductor manufacturing wastewater may be reduced at the first electrode 122E1 of the impurity adsorption device 122, thereby increasing the pH of the semiconductor manufacturing wastewater. When the semiconductor manufacturing wastewater is basic, as the pH of the semiconductor manufacturing wastewater increases, the silicate included in the semiconductor manufacturing wastewater may be dissociated in the form of anions. The silicate dissociated in the form of anions may be adsorbed to the second electrode 122E2 that is a positive electrode of the impurity adsorption device 122. Because the second electrode 122E2 includes or is porous carbon, the silicate anions may be physically adsorbed to a porous structure of the second electrode 122E2. The third voltage may be, for example, about −18 V to about 18 V. The semiconductor manufacturing wastewater on which operation P140 has been performed may be supplied to the second tank 130. Hereinafter, the semiconductor manufacturing wastewater supplied to the second tank 130 is named process treatment water.

Next, in operation P150, silicate effluent may be supplied to the impurity adsorption device 122, and a fourth voltage may be applied to the first electrode 122E1 and the second electrode 122E2 of the impurity adsorption device 122. The fourth voltage may be opposite to the third voltage. When the fourth voltage is applied, the silicate anions adsorbed to the second electrode 122E2 may be desorbed and dissolved in the silicate effluent. Thereafter, the silicate effluent may be collected by the impurity adsorption device 122.

Next, the metal concentration of the process treatment water stored in the second tank 130 may be measured in operation P160. When the metal concentration of the process treatment water is a preset value or less, the process treatment water stored in the second tank 130 may be discharged from the second tank 130 and optionally reused in the semiconductor process. Otherwise, when the metal concentration of the process treatment water is greater than the preset value, the process treatment water stored in the second tank 130 may be supplied to the first tank 110 and retreated by the semiconductor manufacturing wastewater treatment method P100 described above. This process may be repeated one or more times, for example until the process treatment water stored in the second tank 130 has a metal concentration that is a preset value or less and may be discharged from the second tank 130. In example embodiments, process treatment water that is greater than the preset value and supplied to the first tank 110 to be retreated may be supplied to the first tank 110 on its own and run through the adsorption device 120 on its own. In alternative embodiments, process treatment water that is greater than the preset value and supplied to the first tank 110 to be retreated may be supplied to the first tank 110 in combination with new process water entering the first tank 110 from a semiconductor process, and run through the adsorption device 120 with the new process water.

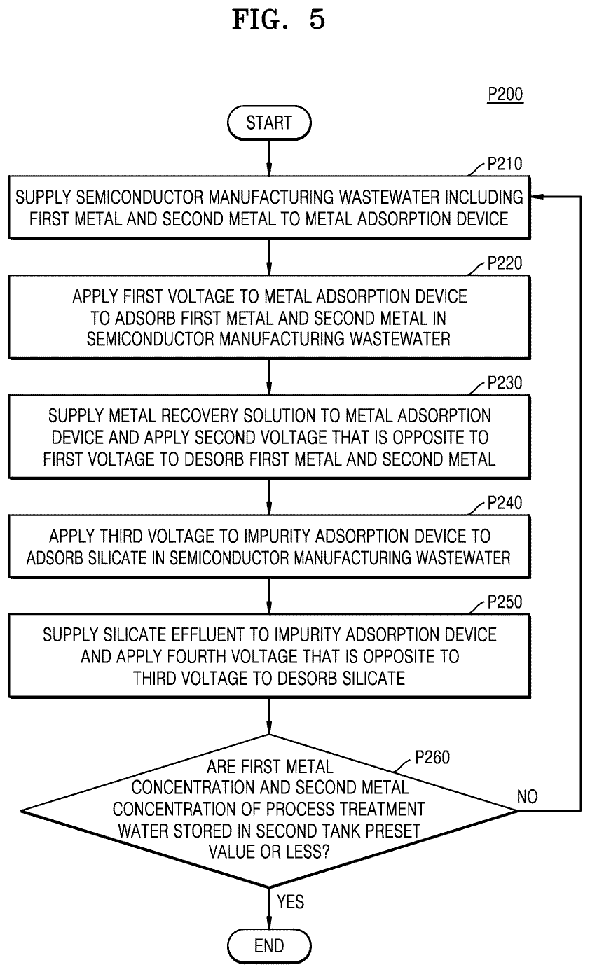

FIG. 5 is a flowchart illustrating an example semiconductor manufacturing wastewater treatment method P200 according to example embodiments.

Referring to FIGS. 1, 2A, 2B, and 5, semiconductor manufacturing wastewater may be supplied from the first tank 110 to the metal adsorption device 121 in operation P210. The semiconductor manufacturing wastewater may be generated by performing a semiconductor process, such as a plating process or a CMP process. The semiconductor manufacturing wastewater in example embodiments, may include at least two types of metals and silicate. The at least two types of metals may include or be at least two types of metals selected from among, for example, Cu, Sn, Ag, Ni, W, Ru, Co, Au, and Ta. For example, the semiconductor manufacturing wastewater may include Cu, Ru, and silicate. It is assumed for convenience of description that the semiconductor manufacturing wastewater in example embodiments includes a first metal, a second metal, and silicate, the first metal and the second metal being different types, but the technical idea of the inventive concept is not limited thereto.

In example embodiments, prior to operation P210 in FIG. 5, the pH of the semiconductor manufacturing wastewater may be adjusted until the semiconductor manufacturing wastewater stored in the first tank 110 is under an acidic condition. When the semiconductor manufacturing wastewater is under an acidic condition, the first metal and the second metal may exist for example, in the form of cations, and the silicate may exist in the form of salt.

Next, the first voltage may be applied to the first electrode 121E1 and the second electrode 121E2 of the metal adsorption device 121 in operation P220. For convenience of description, the semiconductor manufacturing wastewater treatment method P200 is described assuming that the first electrode 121E1 is a negative electrode and the second electrode 121E2 is a positive electrode, but the technical idea of the inventive concept is not limited thereto. (For example, the first electrode 121E1 may be a positive electrode and the second electrode 121E2 may be a negative electrode.) In response to applying the first voltage to the first electrode 121E1 and the second electrode 121E2 of the metal adsorption device 121, first metal cations and second metal cations in the semiconductor manufacturing wastewater may be adsorbed to the first electrode 121E1 that is a negative electrode. Because the first electrode 121E1 includes porous carbon, the first metal cations and second metal cations may be physically adsorbed to the porous structure of the first electrode 121E1. The first voltage may be, for example, about −18 V to about 18 V. The first voltage may be a voltage by which both the first metal cations and the second metal cations may be adsorbed to the first electrode 121E1.

The semiconductor manufacturing wastewater on which operation P220 has been performed may be supplied to the impurity adsorption device 122.

Next, in operation P230, a metal recovery solution may be supplied to the metal adsorption device 121, and the second voltage may be applied to the first electrode 121E1 and the second electrode 121E2 of the metal adsorption device 121. The metal recovery solution may be, for example, ultra-pure water. The second voltage may be opposite to the first voltage. For example, when the first voltage is 1.2 V, the second voltage may be −1.2 V. When the second voltage is applied, the first metal cations and the second metal cations adsorbed to the first electrode 121E1 may be individually desorbed and dissolved in the metal recovery solution. Thereafter, the metal recovery solution may be collected by the metal adsorption device 121 and subsequently treated to recover the first metal and the second metal from the first metal cations and the second metal cations included in the metal recovery solution. Although it is illustrated in FIG. 5 that the second voltage is opposite to the first voltage, the technical idea of the inventive concept is not limited thereto. For example, operation P230 may be performed by supplying the metal recovery solution to the metal adsorption device 121 and applying no voltage to the first electrode 121E1 and the second electrode 121E2 of the metal adsorption device 121. When no voltage is applied to the first electrode 121E1 and the second electrode 121E2 of the metal adsorption device 121, the first metal cations and the second metal cations adsorbed to the first electrode 121E1 of the metal adsorption device 121 by the first voltage may be individually desorbed from the first electrode 121E1.

Next, the third voltage may be applied to the first electrode 122E1 and the second electrode 122E2 of the impurity adsorption device 122 in operation P240. In response to applying the third voltage to the first electrode 122E1 and the second electrode 122E2 of the impurity adsorption device 122, water included in the semiconductor manufacturing wastewater may be reduced at the first electrode 122E1 of the impurity adsorption device 122, thereby increasing the pH of the semiconductor manufacturing wastewater. When the semiconductor manufacturing wastewater is basic, as the pH of the semiconductor manufacturing wastewater increases, the silicate included in the semiconductor manufacturing wastewater may be dissociated in the form of anions. The silicate dissociated in the form of anions may be adsorbed to the second electrode 122E2 that is a positive electrode of the impurity adsorption device 122. Because the second electrode 122E2 includes porous carbon, the silicate anions may be physically adsorbed to the porous structure of the second electrode 122E2. The third voltage may be, for example, about −18 V to about 18 V. The semiconductor manufacturing wastewater on which operation P240 has been performed may be supplied to the second tank 130. Hereinafter, the semiconductor manufacturing wastewater supplied to the second tank 130 is named process treatment water.

Next, in operation P250, silicate effluent may be supplied to the impurity adsorption device 122, and a fourth voltage may be applied to the first electrode 122E1 and the second electrode 122E2 of the impurity adsorption device 122. The fourth voltage may be opposite to the third voltage. When the fourth voltage is applied, the silicate anions adsorbed to the second electrode 122E2 may be desorbed and dissolved in the silicate effluent. Thereafter, the silicate effluent may be collected by the impurity adsorption device 122.

Next, the metal concentration of the process treatment water stored in the second tank 130 may be measured in operation P260. For example, a first metal concentration and a second metal concentration of the process treatment water are a preset value or less, the process treatment water stored in the second tank 130 may be discharged from the second tank 130 and reused in the semiconductor process. Otherwise, when the first metal concentration and the second metal concentration of the process treatment water are greater than the preset value, the process treatment water stored in the second tank 130 may be supplied to the first tank 110 and retreated by the semiconductor manufacturing wastewater treatment method P200 described above.

As with other processes described herein, the process of FIG. 5 may be repeated one or more times, for example until the process treatment water stored in the second tank 130 has a metal concentration that is a preset value or less and may be discharged from the second tank 130. As with other embodiments, in example embodiments of FIG. 5, process treatment water that is greater than the preset value and supplied to the first tank 110 to be retreated may be supplied to the first tank 110 on its own and run through the adsorption device 120 on its own. In alternative embodiments, process treatment water that is greater than the preset value and supplied to the first tank 110 to be retreated may be supplied to the first tank 110 in combination with new process water entering the first tank 110 from a semiconductor process, and run through the adsorption device 120 with the new process water.

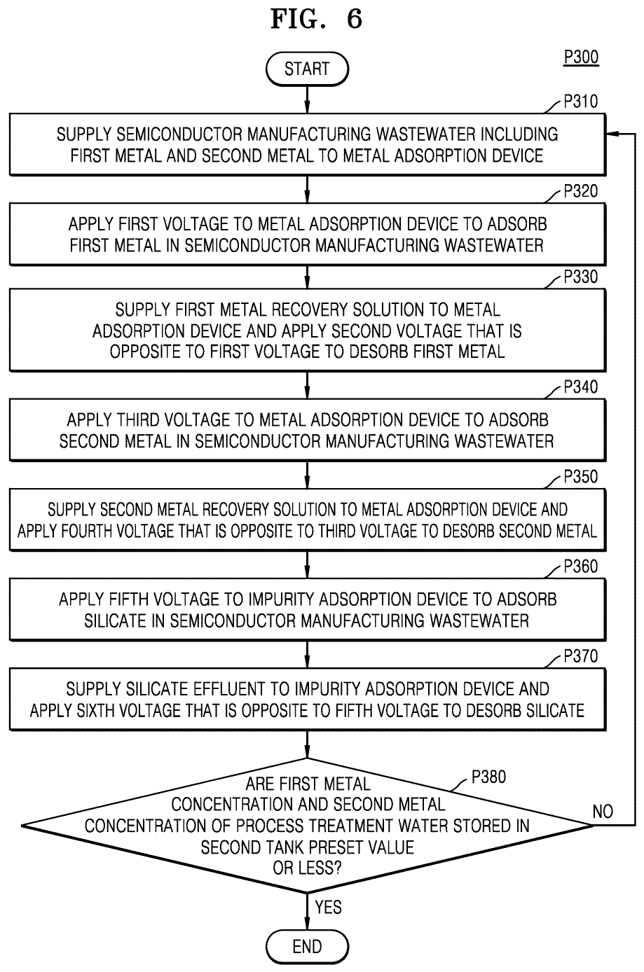

FIG. 6 is a flowchart illustrating an example semiconductor manufacturing wastewater treatment method P300 according to example embodiments.

Referring to FIGS. 3 and 6, semiconductor manufacturing wastewater may be supplied from the first tank 110 to the first metal adsorption device 121a in operation P310. The semiconductor manufacturing wastewater may be generated by performing a semiconductor process, such as a plating process or a CMP process. The semiconductor manufacturing wastewater may include at least two types of metals and silicate. The at least two types of metals may be selected from among, for example, Cu, Sn, Ag, Ni, W, Ru, Co, Au, and Ta. For example, the semiconductor manufacturing wastewater may include Cu, Ru, and silicate. It is assumed for convenience of description that the semiconductor manufacturing wastewater includes a first metal, a second metal, and silicate, the first metal and the second metal being different types, but the technical idea of the inventive concept is not limited thereto.

In embodiments, prior to operation P310, the pH of the semiconductor manufacturing wastewater may be adjusted until the semiconductor manufacturing wastewater stored in the first tank 110 is under an acidic condition. When the semiconductor manufacturing wastewater is under the acidic condition, the first metal and the second metal may exist in the form of cations, and the silicate may exist in the form of salt.

Next, the first voltage may be applied to the first metal adsorption device 121a in operation P320. The first voltage may have a magnitude by which first metal cations may be adsorbed to the negative electrode of the first metal adsorption device 121a, whereas second metal cations may not be adsorbed to the negative electrode of the first metal adsorption device 121a. For example, when the standard reduction potential of the first metal is relatively higher than the standard reduction potential of the second metal, even though a relatively low voltage is applied to the negative electrode of the first metal adsorption device 121a, the first metal may be relatively easily adsorbed and reduced rather than the second metal. Therefore, when the first voltage having a magnitude by which the first metal may be adsorbed to the negative electrode of the first metal adsorption device 121a while the second metal having a lower standard reduction potential than the first metal cannot be adsorbed to the negative electrode of the first metal adsorption device 121a is applied to the first metal adsorption device 121a, the first metal cations may be adsorbed to the negative electrode of the first metal adsorption device 121a, and the second metal cations may not be adsorbed to the negative electrode of the first metal adsorption device 121a. Because the negative electrode of the first metal adsorption device 121a includes porous carbon, the first metal cations may be physically adsorbed to the porous structure of the negative electrode of the first metal adsorption device 121a.

After performing operation P320, the semiconductor manufacturing wastewater may be supplied to the second metal adsorption device 121b.

Next, in operation P330, a first metal recovery solution may be supplied to the first metal adsorption device 121a, and the second voltage may be applied to the first metal adsorption device 121a. The first metal recovery solution may be, for example, ultra-pure water. The second voltage may be opposite to the first voltage. For example, when the first voltage is 1.2 V, the second voltage may be −1.2 V. When the second voltage is applied, the first metal cations adsorbed to the negative electrode of the first metal adsorption device 121a may be desorbed and dissolved in the first metal recovery solution. Thereafter, the first metal recovery solution may be collected by the first metal adsorption device 121a and subsequently treated to recover the first metal from the first metal cations included in the first metal recovery solution. Although it is illustrated in FIG. 6 that the second voltage is opposite to the first voltage, the technical idea of the inventive concept is not limited thereto. For example, operation P330 may be performed by supplying the first metal recovery solution to the first metal adsorption device 121a and applying no voltage to the electrodes of the first metal adsorption device 121a.

Next, the third voltage may be applied to the second metal adsorption device 121b in operation P340. The third voltage may have a magnitude by which the second metal cations may be adsorbed to the negative electrode of the second metal adsorption device 121b. The third voltage may have a larger magnitude than the first voltage. Accordingly, the second metal cations may be adsorbed to the negative electrode of the second metal adsorption device 121b. Because the negative electrode of the second metal adsorption device 121b includes porous carbon, the second metal cations may be physically adsorbed to the porous structure of the negative electrode of the second metal adsorption device 121b.

In example embodiments, each of the first voltage and the third voltage may be about −18 V to about 18 V.

After performing operation P340, the semiconductor manufacturing wastewater may be supplied to the impurity adsorption device 122.

Next, in operation P350, a second metal recovery solution may be supplied to the second metal adsorption device 121b, and the fourth voltage may be applied to the second metal adsorption device 121b. The second metal recovery solution may be, for example, ultra-pure water. The fourth voltage may be opposite to the third voltage. For example, when the third voltage is 1.6 V, the fourth voltage may be −1.6 V. When the fourth voltage is applied, the second metal cations adsorbed to the negative electrode of the second metal adsorption device 121b may be desorbed and dissolved in the second metal recovery solution. Thereafter, the second metal recovery solution may be collected by the second metal adsorption device 121b and subsequently treated to recover the second metal from the second metal cations included in the second metal recovery solution. Although it is illustrated in FIG. 6 that the fourth voltage is opposite to the third voltage, the technical idea of the inventive concept is not limited thereto. For example, operation P350 may be performed by supplying the second metal recovery solution to the second metal adsorption device 121b and applying no voltage to the electrodes of the second metal adsorption device 121b.

Next, a fifth voltage may be applied to the impurity adsorption device 122 in operation P360. In response to applying the fifth voltage to the impurity adsorption device 122, water included in the semiconductor manufacturing wastewater may be reduced at the negative electrode of the impurity adsorption device 122, thereby increasing the pH of the semiconductor manufacturing wastewater. When the semiconductor manufacturing wastewater is basic as the pH of the semiconductor manufacturing wastewater increases, the silicate included in the semiconductor manufacturing wastewater may be dissociated in the form of anions. The silicate dissociated in the form of anions may be adsorbed to the positive electrode of the impurity adsorption device 122. Because the positive electrode of the impurity adsorption device 122 includes porous carbon, the silicate anions may be physically adsorbed to the porous structure of the positive electrode of the impurity adsorption device 122. The fifth voltage may be, for example, about −18 V to about 18 V.

The semiconductor manufacturing wastewater on which operation P360 has been performed may be supplied to the second tank 130. The semiconductor manufacturing wastewater supplied to the second tank 130 may be referred to as “process treatment water” at this stage in the process.

Next, in operation P370, silicate effluent may be supplied to the impurity adsorption device 122, and a sixth voltage may be applied to the impurity adsorption device 122. The sixth voltage may be opposite to the fifth voltage. When the sixth voltage is applied to the impurity adsorption device 122, the silicate anions adsorbed to the positive electrode of the impurity adsorption device 122 may be desorbed and dissolved in the silicate effluent. Thereafter, the silicate effluent may be collected by the impurity adsorption device 122. Next, the metal concentration of the process treatment water stored in the second tank 130 may be measured in operation P380. For example, when a first metal concentration and a second metal concentration of the process treatment water are a preset value or less, the process treatment water stored in the second tank 130 may be discharged from the second tank 130 and reused in the semiconductor process. Otherwise, when the first metal concentration and the second metal concentration of the process treatment water are greater than the preset value, the process treatment water stored in the second tank 130 may be supplied to the first tank 110 and retreated by the semiconductor manufacturing wastewater treatment method P300 described above.

As with other processes described herein, the process of FIG. 6 may be repeated one or more times, for example until the process treatment water stored in the second tank 130 has a metal concentration that is a preset value or less and may be discharged from the second tank 130. As with other embodiments, in example embodiments of FIG. 6, process treatment water that is greater than the preset value and supplied to the first tank 110 to be retreated may be supplied to the first tank 110 on its own and run through the adsorption device 120 on its own. In alternative embodiments, process treatment water that is greater than the preset value and supplied to the first tank 110 to be retreated may be supplied to the first tank 110 in combination with new process water entering the first tank 110 from a semiconductor process, and run through the adsorption device 120 with the new process water.

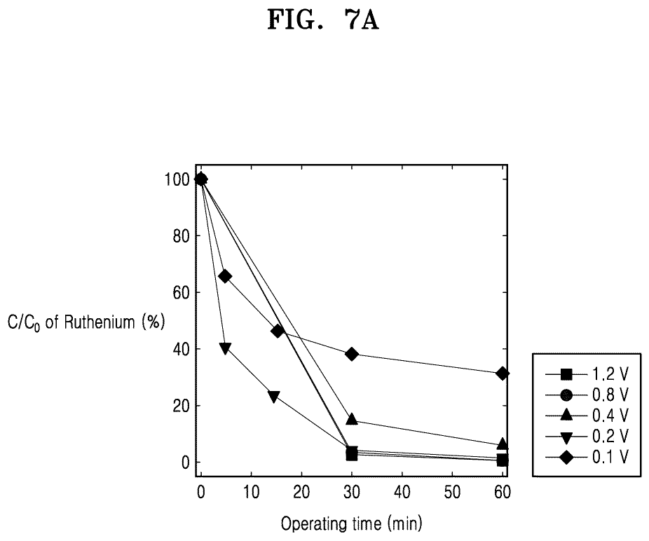

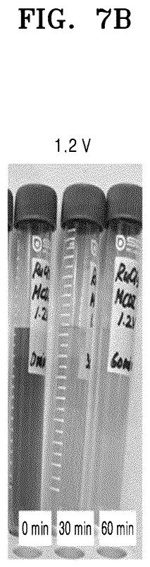

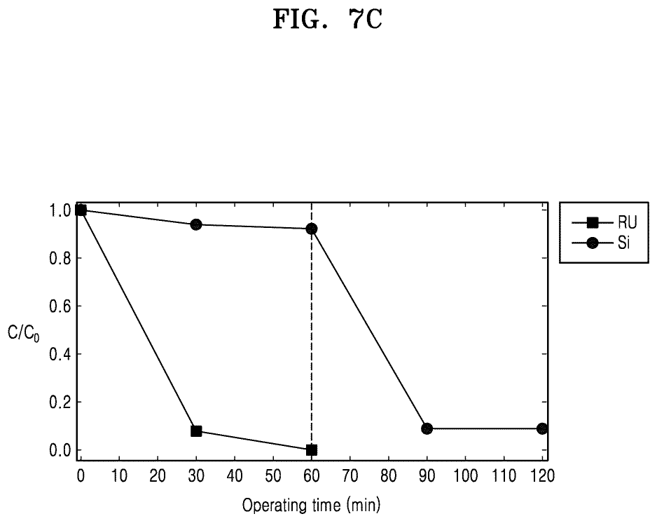

FIG. 7A is a graph illustrating a temporal change in the concentration of a metal included in semiconductor manufacturing wastewater treated by a semiconductor manufacturing wastewater treatment method according to embodiments. Particularly, the horizontal axis of FIG. 7A indicates the time when a voltage is applied to a metal adsorption device, and the vertical axis of FIG. 7A indicates a value obtained by dividing the concentration of the metal included in the semiconductor manufacturing wastewater at a certain time by the initial concentration of the metal and multiplying the division result by 100.

FIG. 7B illustrates a temporal change in the color of the semiconductor manufacturing wastewater treated by the semiconductor manufacturing wastewater treatment method according to embodiments. Particularly, FIG. 7B illustrates the color of the semiconductor manufacturing wastewater before a voltage of 1.2 V is applied to the metal adsorption device, the color of the semiconductor manufacturing wastewater after a voltage of 1.2 V is applied to the metal adsorption device for 30 minutes, and the color of the semiconductor manufacturing wastewater after a voltage of 1.2 V is applied to the metal adsorption device for 60 minutes.

FIG. 7C is a graph illustrating a temporal change in the concentration of each of the metal and silicate included in the semiconductor manufacturing wastewater treated by the semiconductor manufacturing wastewater treatment method according to embodiments. Particularly, the horizontal axis of FIG. 7C indicates the time when a voltage is applied to the metal adsorption device and an impurity adsorption device, and the vertical axis of FIG. 7C indicates a value obtained by dividing the concentration of the metal included in the semiconductor manufacturing wastewater at a certain time by the initial concentration of the metal and multiplying the division result by 100 and a value obtained by dividing the concentration of the silicate included in the semiconductor manufacturing wastewater at a certain time by the initial concentration of the silicate and multiplying the division result by 100. In FIG. 7C, a voltage of 1.2 V is applied to each of the metal adsorption device and the impurity adsorption device.

In FIGS. 7A, 7B, and 7C, the metal included in the semiconductor manufacturing wastewater is Ru, and the initial concentration of Ru included in the semiconductor manufacturing wastewater is 8 ppm to 12 ppm, or 9 ppm to 11 ppm, or about 10 ppm.

Referring to FIGS. 7A, 7B, and 7C, when a voltage of 0.8 V or higher is applied to the metal adsorption device 121 included in the semiconductor manufacturing wastewater treatment system 100 (see FIG. 1) according to embodiments for 30 minutes or longer, about 99.9 % of the metal included in the semiconductor manufacturing wastewater may be adsorbed and recovered.

In addition, referring to FIG. 7C, when a voltage of 1 V to 1.4 V, or 1.1 V to 1.3 V, or 1.2 V is applied to the metal adsorption device 121 included in the semiconductor manufacturing wastewater treatment system 100 (see FIG. 1) according to embodiments for 55 minutes to 65 minutes or 60 minutes, about 99.9 % of the metal may be adsorbed and recovered, and thereafter, the silicate may be separately recovered by applying a voltage of for example, 1.2 V to the impurity adsorption device 122.

Referring to FIGS. 7A, 7B, and 7C, the metal and the silicate included in the semiconductor manufacturing wastewater may be sequentially recovered using the semiconductor manufacturing wastewater treatment system 100 (see FIG. 1) according to example embodiments.

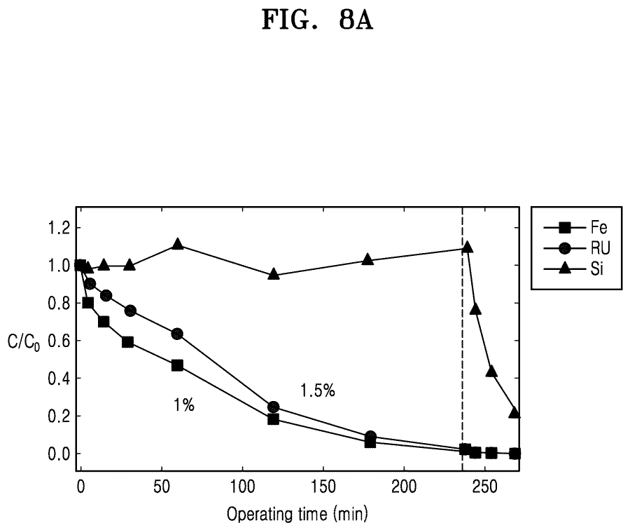

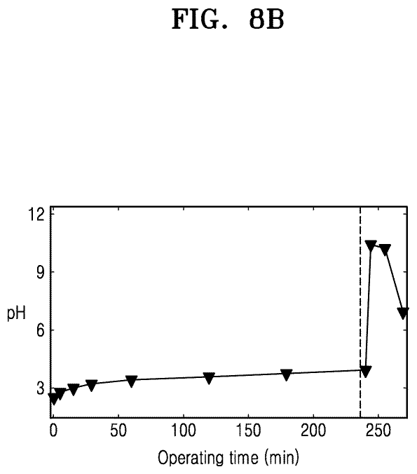

FIG. 8A is a graph illustrating a temporal change in the concentration of each of metals and silicate included in semiconductor manufacturing wastewater treated by a semiconductor manufacturing wastewater treatment method according to embodiments. Particularly, the horizontal axis of FIG. 8A indicates the time when a voltage is applied to a metal adsorption device and an impurity adsorption device, and the vertical axis of FIG. 8A indicates a value obtained by dividing the concentration of a metal included in the semiconductor manufacturing wastewater at a certain time by the initial concentration of the metal and multiplying the division result by 100 and a value obtained by dividing the concentration of the silicate included in the semiconductor manufacturing wastewater at a certain time by the initial concentration of the silicate and multiplying the division result by 100. The line marked with triangles in FIG. 8A indicates the concentration of the silicate included in the semiconductor manufacturing wastewater, the line marked with circles indicates the concentration of Ru, and the line marked with squares indicates the concentration of iron (Fe).

FIG. 8B is a graph illustrating a temporal change in the pH of semiconductor manufacturing wastewater treated by a semiconductor manufacturing wastewater treatment method according to embodiments. Particularly, the horizontal axis of FIG. 8B indicates the time when a voltage is applied to a metal adsorption device and an impurity adsorption device, and the vertical axis of FIG. 8B indicates the pH of the semiconductor manufacturing wastewater.

In FIGS. 8A and 8B, the magnitude of the voltage applied to the metal adsorption device and the impurity adsorption device is 0.2 V to 0.6 V, or 0.3 V to 0.5 V or about 0.4 V, and each of the concentrations of Ru, Fe, and silicate included in semiconductor manufacturing wastewater to be treated is 8 ppm to 12 ppm or about 10 ppm.

Referring to FIGS. 8A and 8B, when a voltage of 0.2 V to 0.6 V, or 0.3 V to 0.5 V, or 0.4 V is applied to the metal adsorption device for 220 to 260 minutes or 240 minutes, about 99% of Fe and about 98.5% of Ru may be recovered, and then when a voltage of 0.3 V to 0.5 V, or 0.4 V is applied to the impurity adsorption device, the pH of the semiconductor manufacturing wastewater may increase to 9 or higher, thereby separately recovering dissociated silicate anions.

Referring to FIGS. 8A and 8B, a first metal, a second metal, and the silicate included in the semiconductor manufacturing wastewater may be sequentially recovered using the semiconductor manufacturing wastewater treatment system 100 (see FIG. 1) according to embodiments.

While the inventive concept has been particularly shown and described with reference to embodiments thereof, it will be understood that various changes in form and details may be made therein without departing from the spirit and scope of the following claims.

A semiconductor manufacturing wastewater treatment system including a first tank configured to store semiconductor manufacturing wastewater containing a metal and silicate; an adsorption device configured to treat the semiconductor manufacturing wastewater supplied from the first tank; a second tank configured to store process treatment water formed by treating the semiconductor manufacturing wastewater by the adsorption device; and a concentration meter configured to measure a metal concentration of the process treatment water, wherein the adsorption device comprises a metal adsorption device configured to recover the metal from the semiconductor manufacturing wastewater supplied from the first tank and including a membrane capacitive deionization (MCDI) device and an impurity adsorption device configured to recover the silicate from the semiconductor manufacturing wastewater treated by the metal adsorption device and including a hybrid capacitive deionization (HCDI) device.

In one embodiment, the first tank is configured to allow a pH of the semiconductor manufacturing wastewater stored in the first tank to be adjusted to an acidic condition

A method of treating semiconductor manufacturing wastewater including supplying semiconductor manufacturing wastewater containing a metal and silicate from a first tank to a metal adsorption device and treating the semiconductor manufacturing wastewater in the metal adsorption device to remove the metal from the semiconductor manufacturing wastewater and recover the metal; supplying the semiconductor manufacturing wastewater treated by the metal adsorption device to an impurity adsorption device and removing the silicate from the semiconductor manufacturing wastewater to form process treatment water; supplying the process treatment water to a second tank; and measuring concentration of the metal in the process treatment water in the second tank.

In one embodiment, the method of treating semiconductor manufacturing wastewater further including discharging the process treatment water when the measured concentration of the metal in the process treatment water is under a predetermined level.

In one embodiment, the method of treating semiconductor manufacturing wastewater further including recirculating the process treatment water to the first tank when the measured concentration of the metal in the process treatment water is above a predetermined level.

In one embodiment, the method of treating semiconductor manufacturing wastewater further including adjusting a pH of the semiconductor manufacturing wastewater to an acidic condition in a first tank, prior to supplying the semiconductor manufacturing wastewater to the metal adsorption device.

In one embodiment, treating the semiconductor manufacturing wastewater in the metal adsorption device to remove the metal from the semiconductor manufacturing wastewater includes applying a first voltage to the metal adsorption device to adsorb a metal from the semiconductor manufacturing wastewater to a negative electrode of the metal adsorption device.

In one embodiment, removing the silicate from the semiconductor manufacturing wastewater includes applying a second voltage to the impurity adsorption device, thereby reducing the semiconductor manufacturing wastewater at a negative electrode of the impurity adsorption device such that a pH of the semiconductor manufacturing wastewater treated by the metal adsorption device is basic and the silicate in the semiconductor manufacturing wastewater is dissociated to silicate anions.

What is claimed is:

1. A semiconductor manufacturing wastewater treatment system comprising:
a first tank configured to store semiconductor manufacturing wastewater containing a metal and silicate; and
an adsorption device configured to treat the semiconductor manufacturing wastewater supplied from the first tank,
wherein the adsorption device comprises
a metal adsorption device configured to recover the metal from the semiconductor manufacturing wastewater supplied from the first tank and
an impurity adsorption device configured to recover the silicate from the semiconductor manufacturing wastewater treated by the metal adsorption device.

2. The semiconductor manufacturing wastewater treatment system of claim 1, wherein the metal adsorption device comprises a spacer, a first electrode disposed below the spacer, a second electrode disposed above the spacer, a first ion exchange membrane disposed between the spacer and the first electrode, and a second ion exchange membrane disposed between the spacer and the second electrode.

3. The semiconductor manufacturing wastewater treatment system of claim 1, wherein the impurity adsorption device comprises a spacer, a negative electrode below the spacer, a positive electrode disposed above the spacer, and an ion exchange membrane disposed between the spacer and the positive electrode.

4. The semiconductor manufacturing wastewater treatment system of claim 1, wherein the first tank is configured to allow a pH of the semiconductor manufacturing wastewater stored in the first tank to be adjusted to an acidic condition.

5. The semiconductor manufacturing wastewater treatment system of claim 1, wherein the metal adsorption device is configured to adsorb metal included in semiconductor manufacturing wastewater to a negative electrode of the metal adsorption device, and to recover the metal.

6. The semiconductor manufacturing wastewater treatment system of claim 1, further comprising:
a second tank configured to store process treatment water formed by treating the semiconductor manufacturing wastewater in the adsorption device; and
a concentration meter configured to measure a metal concentration of the process treatment water.

7. The semiconductor manufacturing wastewater treatment system of claim 6, wherein the wastewater treatment system is configured to discharge the process treatment water from the wastewater treatment system when the measured metal concentration of the process treatment water is a preset value or less, and is configured to circulate the process treatment water from the second tank to the first tank when the measured metal concentration of the process treatment water is greater than the preset value.

8. The semiconductor manufacturing wastewater treatment system of claim 1, wherein the metal adsorption device comprises:
a first metal adsorption device configured to recover the first metal from the semiconductor manufacturing wastewater supplied from the first tank,
a second metal adsorption device configured to recover the second metal from the semiconductor manufacturing wastewater treated by the first metal adsorption device.

9. The semiconductor manufacturing wastewater treatment system of claim 1, wherein the metal included in the semiconductor manufacturing wastewater includes a plurality of metals, and the plurality of metals are capable of being adsorbed to a negative electrode of the metal adsorption device and recovered by applying a second voltage to the metal adsorption device.

10. A semiconductor manufacturing wastewater treatment system comprising:
a first tank configured to store semiconductor manufacturing wastewater containing a first metal, a second metal that is different from the first metal, and silicate; and
an adsorption device configured to treat the semiconductor manufacturing wastewater supplied from the first tank,
wherein the adsorption device comprises
a first metal adsorption device configured to recover the first metal from the semiconductor manufacturing wastewater supplied from the first tank,
a second metal adsorption device configured to recover the second metal from the semiconductor manufacturing wastewater treated by the first metal adsorption device, and
an impurity adsorption device configured to recover the silicate from the semiconductor manufacturing wastewater treated by the second metal adsorption device.

11. The semiconductor manufacturing wastewater treatment system of claim 10, wherein the first metal adsorption device comprises a negative electrode configured to adsorb cations of the first metal recovered by applying a first voltage to the first metal adsorption device, wherein cations of the second metal included in the semiconductor manufacturing wastewater are adsorbed to a negative electrode of the second metal adsorption device and recovered by applying a second voltage to the second metal adsorption device, and the second voltage is higher than the first voltage.

12. The semiconductor manufacturing wastewater treatment system of claim 10, wherein the first tank is configured to allow a pH of the semiconductor manufacturing wastewater stored in the first tank to be adjusted to an acidic condition.

13. The semiconductor manufacturing wastewater treatment system of claim 10, wherein the impurity adsorption device is configured to apply a third voltage to the semiconductor manufacturing wastewater and is configured to adjust a pH of the semiconductor manufacturing wastewater treated by the first metal adsorption device and the second metal adsorption device to be basic.

14. The semiconductor manufacturing wastewater treatment system of claim 10, further comprising:
a second tank configured to store process treatment water formed by treating the semiconductor manufacturing wastewater by the adsorption device; and
a concentration meter configured to measure a metal concentration of the process treatment water.

15. The semiconductor manufacturing wastewater treatment system of claim 14, wherein the wastewater treatment system is configured to discharge the process treatment water from the wastewater treatment system when the measured metal concentration of the process treatment water is a preset value or less, and is configured to circulate the process treatment from the second tank to the first tank when the measured metal concentration of the process treatment water is greater than the preset value.

16. A method of treating semiconductor manufacturing wastewater comprising:
supplying semiconductor manufacturing wastewater containing a metal and silicate from a first tank to a metal adsorption device and treating the semiconductor manufacturing wastewater in the metal adsorption device to remove the metal from the semiconductor manufacturing wastewater and recover the metal;
supplying the semiconductor manufacturing wastewater treated by the metal adsorption device to an impurity adsorption device and removing the silicate from the semiconductor manufacturing wastewater to form process treatment water;
supplying the process treatment water to a second tank; and
measuring concentration of the metal in the process treatment water in the second tank.

17. The method of claim 16, further comprising discharging the process treatment water when the measured concentration of the metal in the process treatment water is under a predetermined level.

18. The method of claim 16, further comprising recirculating the process treatment water to the first tank when the measured concentration of the metal in the process treatment water is above a predetermined level.

19. The method of claim 16, further comprising adjusting a pH of the semiconductor manufacturing wastewater to an acidic condition in a first tank, prior to supplying the semiconductor manufacturing wastewater to the metal adsorption device.

20. The method of claim 16, wherein treating the semiconductor manufacturing wastewater in the metal adsorption device to remove the metal from the semiconductor manufacturing wastewater comprises applying a first voltage to the metal adsorption device to adsorb a metal from the semiconductor manufacturing wastewater to a negative electrode of the metal adsorption device.
